(19) United States
(12) Patent Application Publication
(10) Pub. No.: US 2007/0157765 A1
(43) Pub. Date: Jul. 12, 2007

(54) Package opener

(76) Inventors: Gabe Neiser, Port Jefferson Station, NY (US); Richard Leifer, Melville, NY (US); Alan Randmae, Northport, NY (US)

Correspondence Address: KEUSEY, TUTUNJIAN & BITETTO, P.C., 20 CROSSWAYS PARK NORTH, SUITE 210, WOODBURY, NY, 11797, US

(21) Appl. No.: 11/328,017

(22) Filed: Jan. 9, 2006

(51) Int. Cl. B67B 7/00

(52) U.S. Cl. 81/3.07

(57) ABSTRACT

A clamshell package opener includes a handle to which a housing is attached at a first end. The housing includes a head portion distal to the point of attachment with the handle. The head portion preferably includes an end portion and at least two opposing planar sides. A cutting element is disposed within the head portion and is displaceable longitudinally relative to the housing between a retracted position and an extended position via a blade-deploying mechanism. A curved U-shaped guard is provided for attachment at one of the planar sides. The package opener is adapted such that during use, the cutting element is extended for cutting around the die cut edge of the clamshell package until the user may easily remove the contents of the same.

### BACKGROUND OF THE INVENTION

1. Field of the Invention

The present invention relates to packaging openers, and more particularly, it relates to a package opening device for use with clamshell packaging.

2. Description of Related Art

The use of clamshell packaging is very widespread throughout the retail industry. The implementation of such packaging has enabled manufacturers to provide safe packaging for their products, while at the same time enabling the clear display of the product and/or product inserts without costly additions to the packaging process.

In addition, the technology of the clamshell manufacturing process has also enabled a built-in hanger and/or ‘feet’ to allow the package to be hung on a display rack and/or stand on a display counter without requiring additional hangers or supports. Thus, for at least the above reasons, clamshell packages have become commonplace in the retail world.

Clamshell packaging, however, suffers from one major drawback. The drawback is mainly the difficulty to open these packages that have been heat-sealed closed during the manufacturing process. The heat sealing is generally performed along the outer periphery of the clam shell, or the die cut edge flange. The plastic used in these packages is strong, and difficult, if not impossible to rip open manually. As such, the purchaser is often required to cut the package open with a sharp razor blade or knife, which subjects the purchaser to a high possibility of a self-inflicted injury due to the often unusual and varied shapes of the clamshell packages. Indeed, during the opening of these clamshell packages, the purchaser is often either injured, or the contents of the package are damaged.

Thus, it would be desirable to provide a tool or device for opening a clamshell package accurately that eliminates the need for the purchaser to use knives or other potentially dangerous instruments to open the package and which enables the purchaser to easily open the package without damaging the contents thereof.

### SUMMARY OF THE INVENTION

It is therefore an aspect of the invention to provide a clamshell package opener that provides a safe and easy way for opening such packages.

It is yet another aspect of the invention to provide a clamshell package opener that does not subject the user to exposure to sharp instruments.

A further aspect of the invention is to provide a clamshell package opener that does not damage the contents of such package.

These and other aspects are achieved in accordance with an embodiment of the invention wherein a clamshell package opener includes a head portion having an end portion and at least two opposing planar sides. A cutting element is disposed within the head portion and extendable from the end portion. When the cutting element is extended, the distance between the cutting element and each planar side of the head portion is less than or equal to about 0.04 inches.

According to another aspect of the present invention, a package opener is provided including a housing including a head portion at a first end, the head portion including an end portion and at least two opposing planar sides. A handle is provided attached to a second end of the housing, and a cutting element is disposed within the housing, the cutting element being displaceable longitudinally relative to the housing between a retracted position and an extended position in which at least a portion of the cutting element is protruded from the end portion. The distance between the cutting element in the extended position and at least one of the planar sides of the head portion is less than or equal to about 0.04 inches. A guard is provided comprising a curved member having a first end attached to one of said planar sides.

Other aspects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings wherein like reference numerals denote similar components throughout the views:

FIG. 1 is a side perspective view of an exemplary package opener according to an aspect of the present invention;

FIG. 2 is a front perspective view of a portion “A” of an exemplary package opener according to an aspect of the present invention;

FIG. 3A is a partial side cut-away view of mechanical parts and a handle of an exemplary package opener according to an aspect of the present invention;

FIG. 3B is a partial side cut-away view of mechanical parts and a handle of an exemplary package opener according to another aspect of the present invention;

FIG. 4 is a perspective view of an exemplary clamshell package;

FIG. 5 is an enlarged view of the die cut edge of an exemplary clamshell package; and

FIG. 6 is a front view of an exemplary package opener positioned to open a clamshell package according to an aspect of the present invention.

### DETAILED DESCRIPTION OF PREFERRED EMBODIMENTS

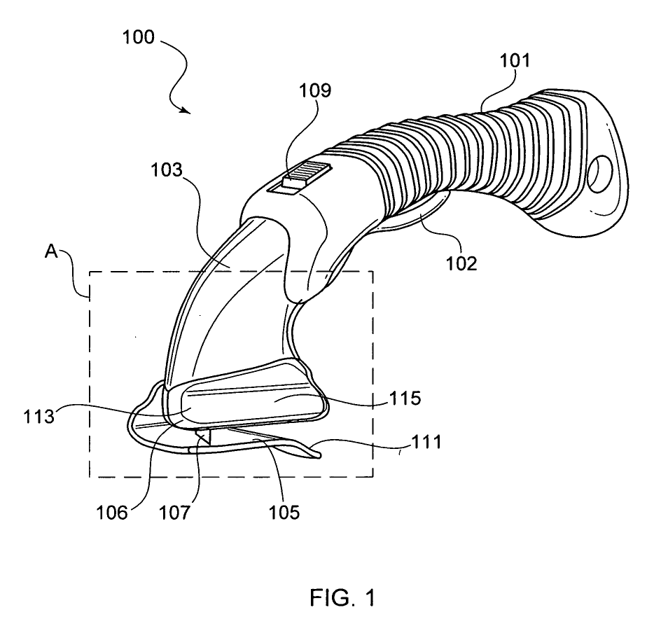

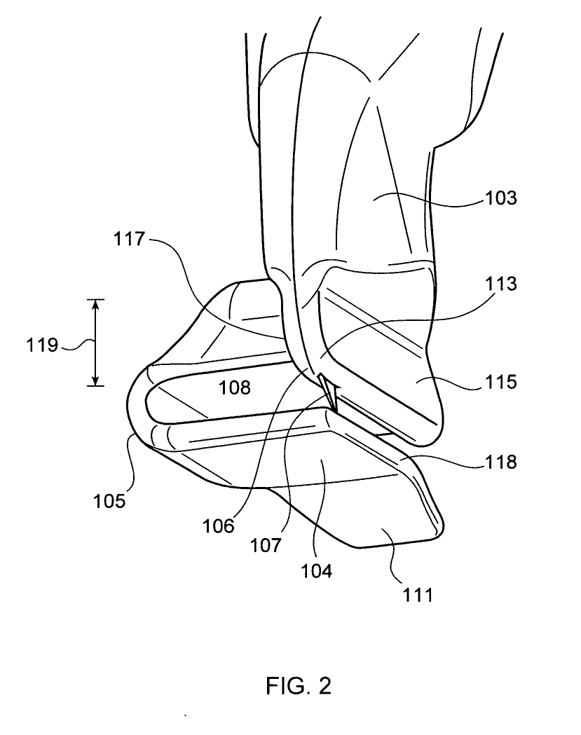

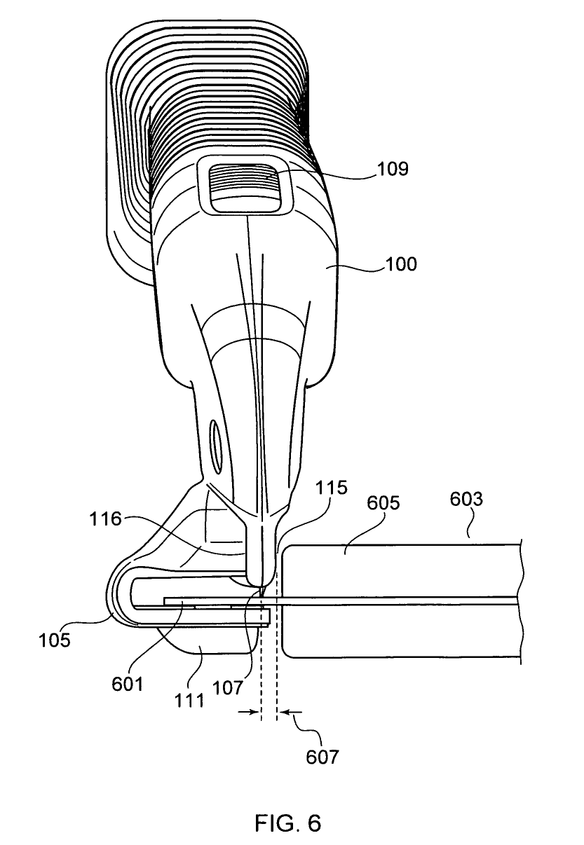

FIGS. 1-3 show various views of an exemplary package opener according to an aspect of the invention. The package opener 100 comprises a handle 101 to which a housing 103 is attached at a first end. The handle 101 may include a rubber grip preferably molded and contoured to maximize ergonomic fit and comfort. The housing 103 includes a head portion 113 distal to the point of attachment with the handle 101; the head portion 113 preferably includes an end portion 106 and at least two opposing planar sides 115 and 116 (shown in FIG. 6).

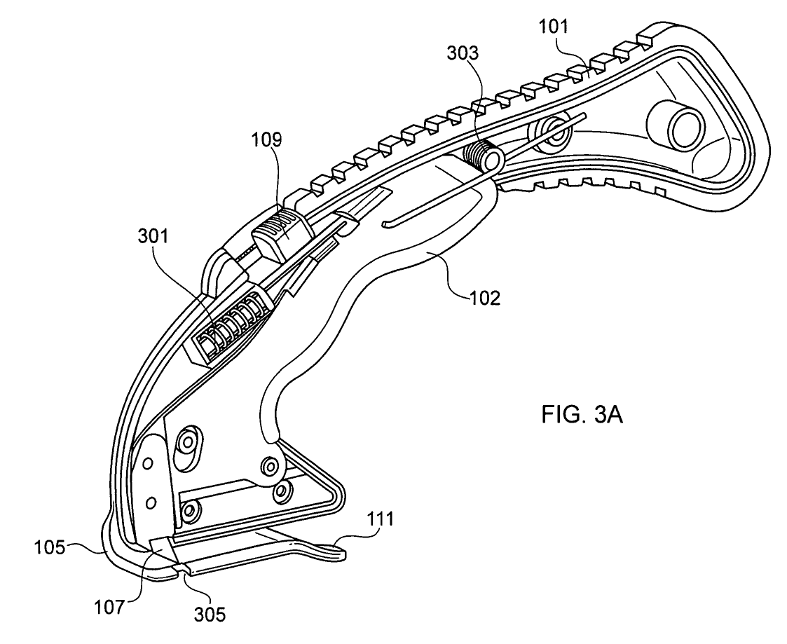

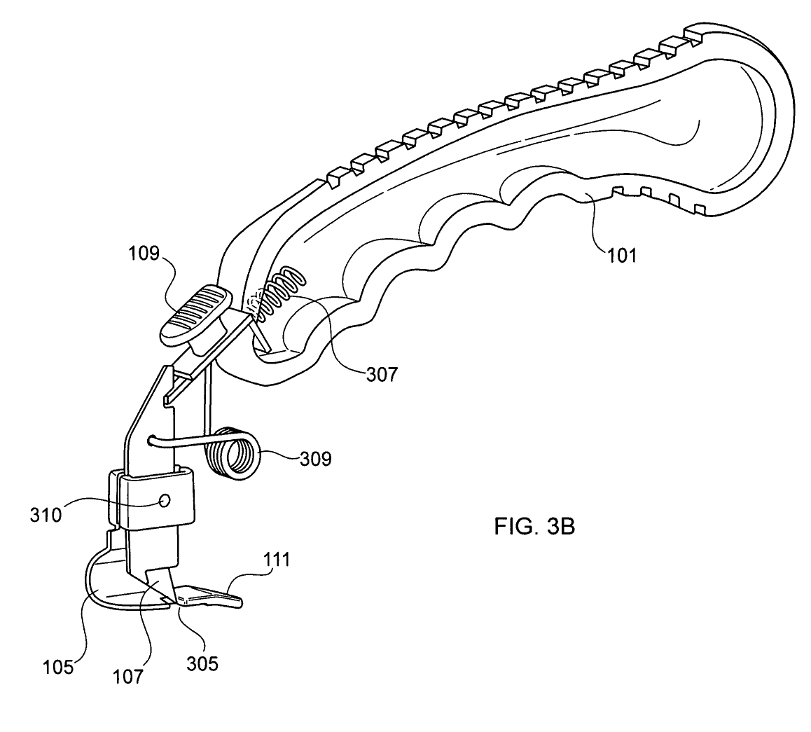

The housing 103 is adapted for housing a cutting element 107 (e.g., a blade) internally, which, in one embodiment, may be enabled to be extended via a blade-deploying mechanism (e.g., a trigger 102 which may be located, for example, on the underside of the handle 101 or in any other preferably ergonomic location on the package opener 100). The cutting element 107 is displaceable longitudinally relative to the housing between a retracted position in which the cutting element 107 is completely enclosed within said housing 103, and an extended position in which at least a portion of the cutting element 107 is caused to be protruded/extended from the housing 103 (e.g., namely, from the end portion 106) and thus exposed for, e.g., cutting a surface. Preferably, the cutting element 107 is caused to be protruded under tension; such displacement may be achieved via incorporation of various mechanical elements such as springs, biasing means, pivots, tension means, etc. which connect the cutting element 107 with the handle 101 (e.g., discussed further below with reference to FIG. 3).

A guard 105 (having a first edge 117 and a second edge 118) is provided for attachment at the first edge 117 to one side of the housing 103, preferably at one of the planar sides 115. The guard 105 preferably comprises a curved (e.g., an elongate U-shaped) member having a substantially flat upper wall 108 joined with a lower wall 104 defining, e.g., a U-shaped cavity and includes a flared edge 111, although alternate shapes and configurations may be contemplated. The flared edge 111 is preferably attached or integrated with the guard, and is preferably located at a bottom piece of the guard 105 as shown; for example, the flared edge 111 may comprise a downwards continuous extension of edge 118. The guard 105 is designed to protect the housing 103, in particular the head portion 113 from torsion and bending, as well as prevent unintentional or accidental contact with the blade 107, and may be comprised of a single integral piece or multiple attached pieces. The first edge 117 of the guard 105 is preferably of an increased thickness 119 (e.g., of a greater thickness than the second edge 118 of the guard), such that its surface area of attachment with the head portion 113 is maximized for increased stability. The guard 105 may include a cut-out portion 305 (shown in FIGS. 3A and 3B) for allowing pass-through of at least a partial length of the blade tip, such that e.g., during use of the package opener, the blade 107 is assured full and complete penetration through an edge of a clamshell package positioned for cutting.

In the exemplary Figures shown, the guard 105 is depicted attached to the right side of the package opener housing 103 for facilitating, e.g., right-handed cutting. However, the guard 105 may be affixed to the left side thereof for, e.g., left-handed cutting, and/or may be removable to permit manual detachment/attachment.

FIGS. 3A and 3B are partial side cut-away views of exemplary mechanical parts and a handle of a package opener according to various embodiments of the present invention. For example, in one exemplary embodiment, as shown in FIG. 3A, the package opener may include the trigger 102 which when depressed, deploys the blade 107. In this embodiment, the guard 105 is stationary and non-movable, and affixed to the housing 103. Blade deployment is caused by activation of the trigger mechanism 102.

In an alternate embodiment (e.g., as shown in FIG. 3B), the trigger 102 is not provided; instead, the guard 105 is functionally attached to the blade 107, e.g., via a pin 310 inserted therethrough, such that movement of the guard 105 causes movement of the blade 107. In this embodiment, for example, a clamshell package edge (e.g., 501) loaded into the package opener for cutting (e.g., slid from edge 111 onto the guard 105) causes a downwards force to be exerted on the guard due to the thickness of its edge. The downwards force on the guard 105 in turn forcibly moves blade 107 downwards for puncturing and cutting the clamshell package edge.

A package opener according to any embodiment of the present invention may include automatic blade retraction capability as a safety feature. The extension and retraction of the cutting element 107 as well as an automatic blade retraction feature may be enabled via use of various coils and springs, for example: a tension coil 301 and/or 307 having a first end affixed to the handle 101 and a second end functionally attached to the locking mechanism 109, and/or a pivotable spring 303 having a first end attached to the handle 101 and a second end functionally attached to the trigger mechanism 102, or, e.g., as shown in the embodiment of FIG. 3B, a pivotable spring 309, having a first end attached to the blade 107 and a second end functionally attached to the locking mechanism 109. For example, the pivotable spring 303 may provide resistance upon squeezing of the trigger 102 which in turn deploys the blade 107, and thereafter upon release of the trigger 102, enables automatic retraction of the blade 107. The pivotable spring 309 may provide resistance upon downwards pressure on the guard 105 and thereafter upon release of such pressure, enables automatic retraction of the blade 107.

In one example, springs 301, 303, 307 and/or 309 may bias the cutting element 107 in a retracted position. Once cutting element 107 is deployed (e.g., via activation of trigger mechanism 102 or insertion of a package edge onto the guard 105), the blade 107 engages (punctures) the package and the opener 100 may be pulled along the package edge to commence the cutting action. Preferably, in the trigger mechanism embodiment, the trigger mechanism 102 is depressed throughout the cutting procedure in order to keep the blade 107 deployed. Upon release of the trigger mechanism 102, the blade 107 preferably automatically retracts into the housing 103 via springs (e.g., 301, 303). It is to be understood that various alternate means for effectuating the desired mechanical features of blade extension, retraction and/or automatic retraction may be contemplated.

As an additional or alternative safety feature, a locking mechanism 109 may be provided to lock/unlock the blade-deploying mechanism (e.g., the trigger mechanism 102 or the movable guard embodiment of FIG. 3B). Preferably, the locking mechanism 109 is not required to deploy or retract the blade, but functions to unlock and release the trigger mechanism 102 to function.

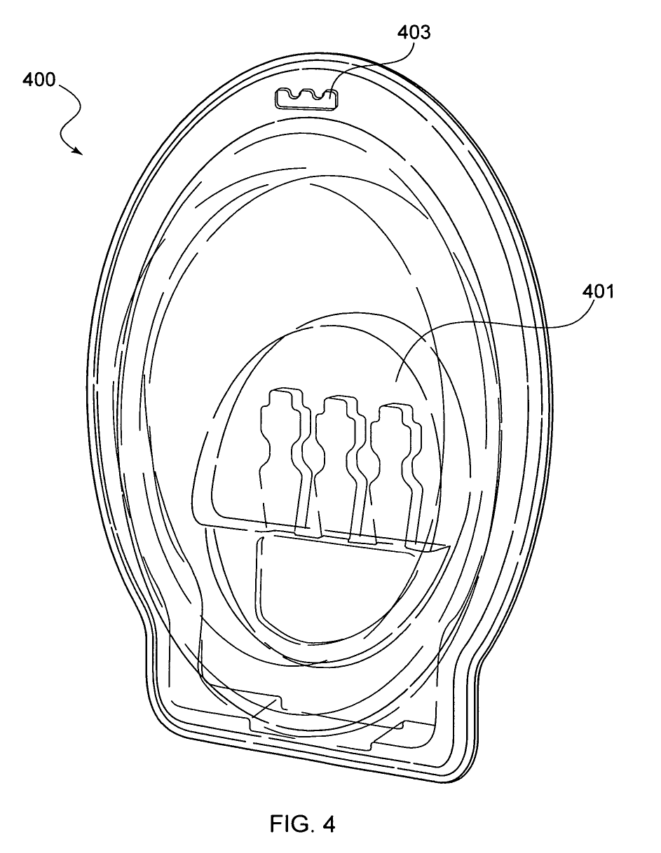

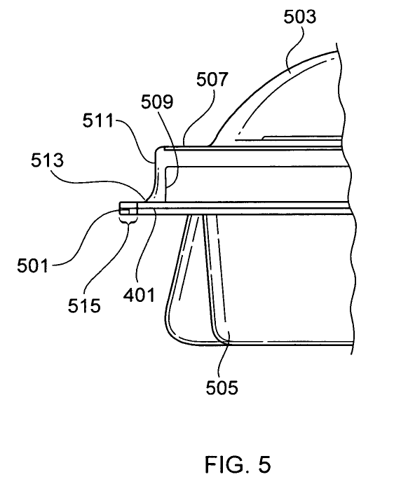

Referring to FIGS. 4 and 5, an exemplary clamshell package 400 is shown having a die cut edge 401 defining a flange 501 around the entire peripheral edge of the package. A top clam portion 503 is joined with a base portion 505 along a structural flange 507, and adhered to the same via the die cut edge 401. The clamshell package can include a die cut hanging hole 403 for allowing the sealed clamshell package to be hung on a display rack. In other forms (not shown), the clamshell can include molded feet like structures in the bottom which enable the sealed clamshell package to stand on a display counter, or in a display box.

The die cut edge 401 of the flange 501 includes a portion 515 along the outer most periphery where the actual heat is applied and the upper clam 503 and lower clam 505 are physically connected. The upper clam 503 has a lower portion 511 that meets with the upper portion 509 of the lower package 505 to form the flange 501 and ultimately the die cut edge 401. As shown, the die cut edge 401 includes the sealed portion 515 and an adjacent unsealed portion 513 where the upper clam 503 and lower clam 505 are together, but not sealed. It is in this area of adjacent portion 513 where it is preferred to cut open the package such that any inserts supported by structural flange 507 and/or any products contained in the package are not damaged during opening.

FIG. 6 is a front view of an exemplary package opener 100 positioned to open a clamshell package 403 according to an aspect of the present invention. For example, to open a clamshell package, an edge 601 of the clamshell package 603 is inserted within the U-shaped recess of the guard 105 until the side 115 of the housing 103 substantially abuts a top clam portion 605 of the clamshell package 603. In a preferred embodiment, the distance 607 between blade 107 and side 115 is less than or equal to about 0.04 inches. This assures puncturing of the clamshell package in and along the area of its unsealed portion (e.g., equivalent to unsealed portion 513), which is described above as being the preferred area to cut.

When the edge of the clamshell package 403 is properly inserted for cutting, (and if the package opener 100 includes a locking mechanism 109, the locking mechanism 109 has been unlocked), the trigger mechanism 102 may be deployed which preferably causes a forceful downwards retraction of the blade 107, thus puncturing the package edge 401. Using the handle 101, the opener 100 may then be pulled along the die cut edge 401, pressing the side 115 to the side wall of the top clam 605 as a guide, to slit open the package 603 neatly and precisely at its unsealed portion.

It is to be noted that when the package opener 100 is properly positioned for cutting the type of clamshell packaging as shown in FIG. 5, the side wall 115 preferably abuts the wall of the lower portion 511, so that the unsealed portion 513 is punctured and cut by the blade 107.

According to an aspect of the invention, the blade 107 may be provided at an angled position and/or have an angled/customized shape, e.g., such that when the blade 107 is cutting a package, instead of being parallel to the cutting flange, it is slightly angled into the package. Thus, the blade acts as a ship rudder steering the blade into the package while being pulled for cutting. Namely, this facilitates puncturing of the package, as well as provides a “hook” force to grab the cutting surface and maintain engagement during the cutting process. For example, the blade angle on the cutting side may be “undercut” to pull the plastic ‘upward’ so as to force engagement and provide a wedge or stop which facilitates cutting.

According to another aspect of the invention, the blade 107 may include a modified or tapered edge, e.g., the blade may include a cutting edge that is ‘double honed’ so as to exhibit a variation in thickness from front to back Advantageously, this further improves the cutting process. It is to be noted that alternate modifications of the blade 107 may be contemplated to facilitate the cutting process.

While there have been shown, described and pointed out fundamental novel features of the invention as applied to preferred embodiments thereof, it will be understood that various omissions, substitutions and changes in the form and details of the methods described and devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed, described or suggested form or embodiment as a general matter of design choice. It is the intention, therefore, to be limited only as indicated by the scope of the claims appended hereto.

What is claimed is:

1. A package opener comprising:
a housing including a head portion at a first end, the head portion including an end portion and at least two opposing planar sides; and
a cutting element disposed within said head portion and extendable from said end portion, wherein said cutting element is displaceable longitudinally relative to the housing between a retracted position and an extended position via a blade-deploying mechanism.

2. The package opener of claim 1, wherein when the cutting element is extended, a distance between the cutting element and each planar side of the head portion is less than or equal to about 0.04 inches.

3. The package opener of claim 1, further comprising a guard comprising a curved member having a first edge attached to one of said planar sides.

4. The package opener of claim 3, wherein the guard comprises an elongate U-shaped member defining a U-shaped cavity within.

5. The package opener of claim 3, wherein the guard includes a flared edge.

6. The package opener of claim 3, wherein in the guard is movably attached to the cutting element.

7. The package opener of claim 1, further comprising a locking mechanism for locking and unlocking the blade-deploying mechanism.

8. The package opener of claim 1, further including a pivotable spring having a first end attached to the handle and a second end attached to the blade-deploying mechanism.

9. A clamshell package opener comprising:
a housing including a head portion at a first end, the head portion including an end portion and at least two opposing planar sides;
a handle attached to a second end of the housing;
a cutting element disposed within said housing, wherein said cutting element is displaceable longitudinally relative to the housing between a retracted position and an extended position via a blade-deploying mechanism; and
a guard comprising a curved member having a first end attached to one of said planar sides.

10. The package opener of claim 9, wherein the guard comprises an elongate U-shaped member defining a U-shaped cavity within.

11. The package opener of claim 9, wherein the guard includes a flared edge.

12. The package opener of claim 9, wherein the attached first end of the guard is of an increased thickness than a second edge of the guard.

13. The package opener of claim 9, wherein the guard includes a cut-out portion, for receiving at least a partial length of the cutting element in the extended position.

14. The package opener of claim 9, wherein the blade-deploying mechanism comprises a trigger operably attached to the cutting element for enabling extension of the cutting element when activated.

15. The package opener of claim 9, further comprising a locking mechanism for locking and unlocking the blade-deploying mechanism.

16. The package opener of claim 9, further including a pivotable spring having a first end attached to the handle and a second end attached to the blade-deploying mechanism.

17. The package opener of claim 9, wherein at least a portion of the cutting element is protruded from the end portion, and a distance between the protruded cutting element in the extended position and at least one of the planar sides of the head portion is less than or equal to about 0.04 inches.
